(19) United States
(12) Patent Application Publication
(10) Pub. No.: US 2026/0077708 A1
(43) Pub. Date: Mar. 19, 2026

(54) VEHICLE FRONT ALERT SYSTEM FOR USE IN A SCHOOL BUS

(71) Applicant: Pedestrian Safety Solutions, LLC, New York, NY (US)

(72) Inventor: Paul L. Schaye, Delray Beach, FL (US)

(73) Assignee: Pedestrian Safety Solutions, LLC, New York, NY (US)

(21) Appl. No.: 19/280,312

(22) Filed: Jul. 25, 2025

Related U.S. Application Data
(60) Provisional application No. 63/696,038, filed on Sep. 18, 2024.

(51) Int. Cl. B60Q 1/50; B60Q 1/26

(52) U.S. Cl. CPC B60Q 1/543; B60Q 1/2603; B60Q 1/2626; B60Q 1/2696; B60Q 1/525; B60Q 2400/20; B60Q 2800/30

(57) ABSTRACT

A visual alert assembly for use with a school bus having a rear shell seating one or more PC boards integrating illuminating elements. A forward facing outer perimeter mounting surface of the shell includes an adhesive adapted to mount the assembly to a glass associated with any of a forward windshield or rear window of the vehicle so that the illuminating elements are visible through the glass. Each of external power and control inputs extending through the rear shell and communicates with the PC boards for operating the illuminating elements according to any of intensity, color or pattern in response to a change in a travel condition of the vehicle.

### CROSS REFERENCE TO RELATED APPLICATIONS

The present application claims the priority of U.S. Ser. No. 63/696,038 filed Sep. 18, 2024.

### FIELD OF THE INVENTION

The present invention relates generally to vehicle alert systems for use in notifying pedestrians and others as to the travel condition of a vehicle. More specifically, the present invention teaches an alert system for use with a school bus which provides visual information to any other driver or pedestrian when it is traveling at speed, slowing, or stopping, such as during loading or unloading of passengers.

### BACKGROUND OF THE INVENTION

The prior art discloses examples of vehicle alert systems to such as other drivers and pedestrians. A first example of a vehicle front alert system is disclosed in U.S. Pat. No. 10,981,496 to Schaye, which teaches a visual deceleration indicator signal to pedestrians and other vehicles that a vehicle is slowing down or coming to a stop. Illuminating devices, such as light emitting diodes, are located in the front of the car and are activated when the vehicle decelerates. An accelerometer or other sensing device detects deceleration and sends a signal to illuminate the LED's, thereby letting others know the vehicle is slowing down.

U.S. Pat. No. 11,263,899 to Ekin, teaches a retrofittable modular school bus safety apparatus having a CPU, a plurality of sensors and scanners, an electrical plug device, and an output device. The electrical plug device is preferably adapted to plug into an auxiliary power port, a USB port or an OBD (on board diagnostic) port to provide electrical power to the apparatus and to provide actuable communication to school bus devices such as lights, horns, crossing arm, etc. The sensors include machine vision sensors, proximity detection sensors, and speed detection sensors. The apparatus is adapted to “read” a vehicle's license plate via ALPR, perform facial recognition, automatically monitor and warn/alert traffic proximate the school bus, to automatically respond with an appropriate level of response depending on an observed level of a moving violation, and to automatically wirelessly obtain the traffic laws/regulations applicable to location of the school bus and to operate accordingly.

Other references of note include the system for signaling vehicle deceleration set forth in U.S. Pat. No. 11,014,492 to Hence having an acceleration sensor, processor, lamp controller, power supply, mount and lamp. The acceleration sensor gathers acceleration data of the vehicle, which the processor interprets and, based on that data, determines that the vehicle is decelerating beyond a preset threshold, at which the processor powers the lamp via the lamp controller.

Takori, U.S. Pat. No. 11,524,628 teaches a notification device in a vehicle which enables a person outside the vehicle to be notified of a predetermined operating state of the vehicle by the light emission. A plurality of spot-shaped light sources are arranged at intervals to follow an upper edge of a windshield. A reflecting part reflects light from the light sources to a front; an outer lens transmitting therethrough the light heading toward the front from the reflecting part; and a housing. The outer lens has on at least one of front and rear faces thereof a concave-convex face diffusing the light transmitted through the outer lens. The device is visible through an upper part of the windshield from a person outside the vehicle and the light from the relatively small spot-shaped light source can be sufficiently diffused so that visibility can be further enhanced.

Finally, US 2020/0282895 to Yi teaches a system to enhance vehicle safety including at least one visual signal light apparatus positioned in the proximity to a front end of a vehicle, the visual signal light apparatus illuminating when the vehicle is decelerating via its braking system. A visual light apparatus includes at least a main component and a mount component; wherein the mount component is suitable to mount the main component to a surface of the front of the vehicle. The main component includes a housing, an LED array, and a solar array, with the housing including a recessed portion housing the LED array so that it faces the front end of the vehicle, and wherein a solar array is embodied to a top surface of the housing.

### SUMMARY OF THE INVENTION

The present invention discloses a visual alert assembly for use with a school bus which signals each of travel/going and slowing conditions, such as to pedestrians and other drivers. In a non-limiting embodiment, the lighting assembly is configured as a strip shaped component which is populated with a number of LED or other illuminating elements incorporated into a flex circuit. Other structural features include each of a lens cover, LED supporting component, PCB and backing or support.

The LED arrangement can include any suitable color scheme utilized in the assembly and, in one non-limiting application, include a pattern of RED, WHITE, AMBER alternated colored lighting extending across the length of the strip, with the intensity of the illumination optionally being variable depending upon need and application. When the school bus is moving, the WHITE LEDs will shine. As the bus slows/starts to stop, the AMBER LEDs will turn on and remain lit until the bus comes to a complete STOP. At this point, the RED LEDs will glow and (optionally) flash on-off, signaling children may be exiting the bus.

In the instance of buses with two separate front windows separated by a pillar bar in the middle, a pair of strips can be incorporated near the top of the windshield. Alternatively, a single strip could be used in the middle of the windshield for buses with continuous long-glass windshields. Additionally, two strips would be mounted at the rear glass near the top and in sync with the front devices. The behavior would be the same between the front and back devices.

In operation, the present invention would give any driver or pedestrian visual information about what the bus is doing, i.e. when it is going, stopping and entirely stopping, and unloading or loading children. In one non-limiting embodiment, the unit is powered from a 12 v DC source and incorporates X-Y-Z motion detection in order to detect the bus moving forward and then stopping, and the Z axis would handle left-right turns that might require a stop or acceleration during a turn or a complete STOP in a turn.

In a further non-limiting embodiment, the visual alert assembly includes a rear shell seating one or more PC boards integrating LED elements, with covering acrylic optics, along with two sided mounting tape for securing a forward facing outer perimeter mounting surface of the shell of the assembly to an inner windshield surface. A combination of support ribs and snap clips are configured within upper and lower recessed inner edges of the shell for securing the PCB boards rearwardly of the forward facing mounting surface of the shell. Self-tapping screws are provided for securing the acrylic optic cover elements to the forward facing side of the PCB boards, prior to the boards being mounted to the shell.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an assembled perspective of the visual lighting apparatus according to a non-limiting embodiment of the present invention;

FIG. 2 is an exploded view of the visual lighting apparatus of FIG. 1 and which includes each of the lens cover, LED supporting component, PCB and backing;

FIG. 3 is an environmental view of a school bus incorporating a pair of visual lighting apparatuses in a steady travel/going condition;

FIG. 4 is a further environmental view depicting the bus in a slowing condition;

FIGS. 5A-5F present a progression of environmental views depicting first and second versions of the visual lighting apparatus mounted to a forward facing upper windshield location of a school bus according to a non-limiting embodiment; and

FIGS. 6A-6I present a further progression of environmental views depicting a series of additional versions of the visual lighting apparatus mounted to one or more rear windows of the school bus.

FIG. 7 is an exploded view of the visual lighting apparatus according to a further non-limiting embodiment of the present invention;

FIG. 8 is a rotated view of FIG. 5 and better illustrating each of the base or shell, LED supporting PCB boards, covering acrylic optics and two sided mounting tape;

FIG. 9 presents a partial cutaway of an assembled visual lighting apparatus as shown in FIG. 7;

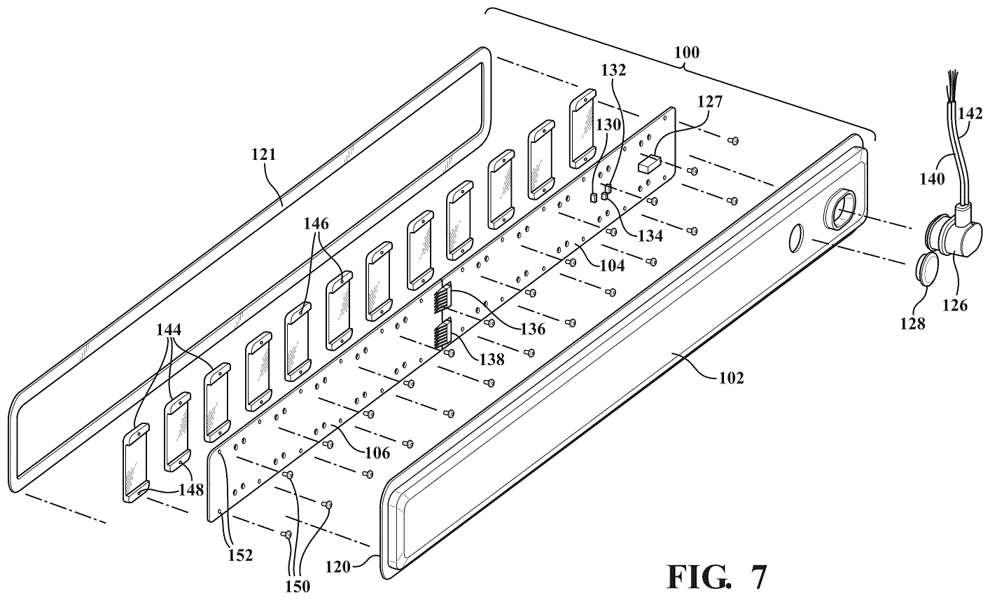

FIG. 10 presents an enlarged sectional view of a shell to PCB board upper edge connection interface as shown in area 10 of FIG. 9 including a support rib for receiving snap clips;

FIG. 11 presents an enlarged sectional view of the shell to PCB board lower edge connection interface as shown in area 11 of FIG. 9 and including snap clips for holding the PC board in place;

FIG. 12 is a further enlarged view similar to FIG. 9 of the assembled visual lighting apparatus of FIG. 5 et seq. and better showing the self-tapping screws for securing the acrylic optic cover elements to the forward face of the PCB boards;

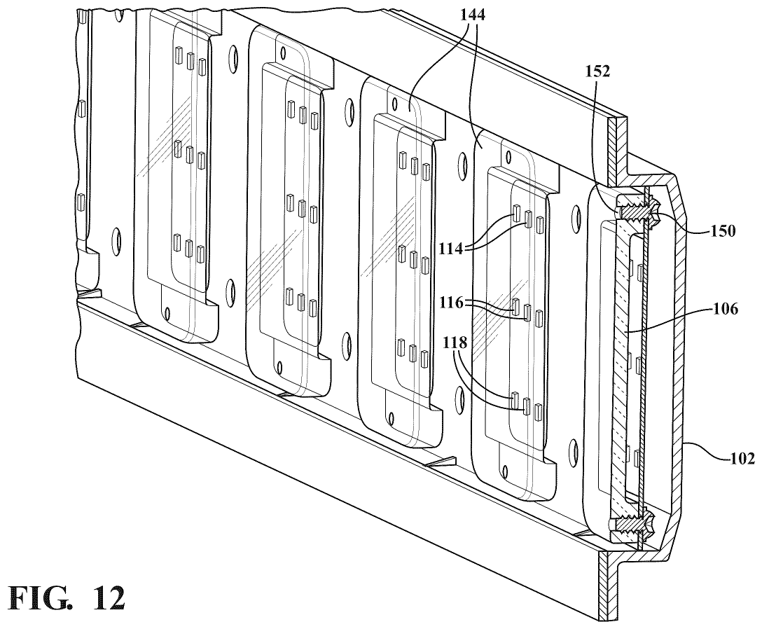

FIG. 13 presents a front looking overall perspective view of the visual lighting apparatus of FIG. 7 et seq.;

FIG. 14 presents a rotated rear looking perspective view of the assembled visual lighting apparatus of FIG. 13; and

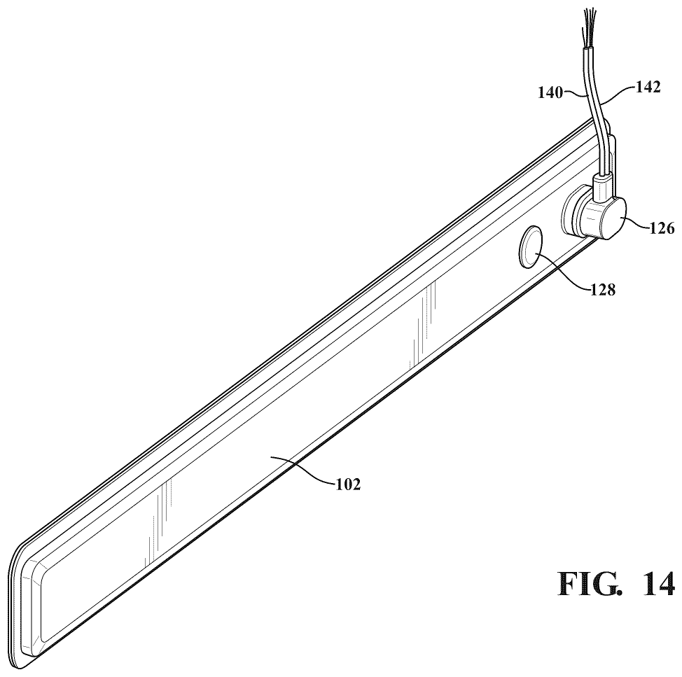

FIG. 15 presents and enlarged end perspective of FIG. 14 and better illustrating the power and controller inputs accessible through the rear of the shell.

### DETAILED DESCRIPTION OF THE PREFERRED EMBODIMENTS

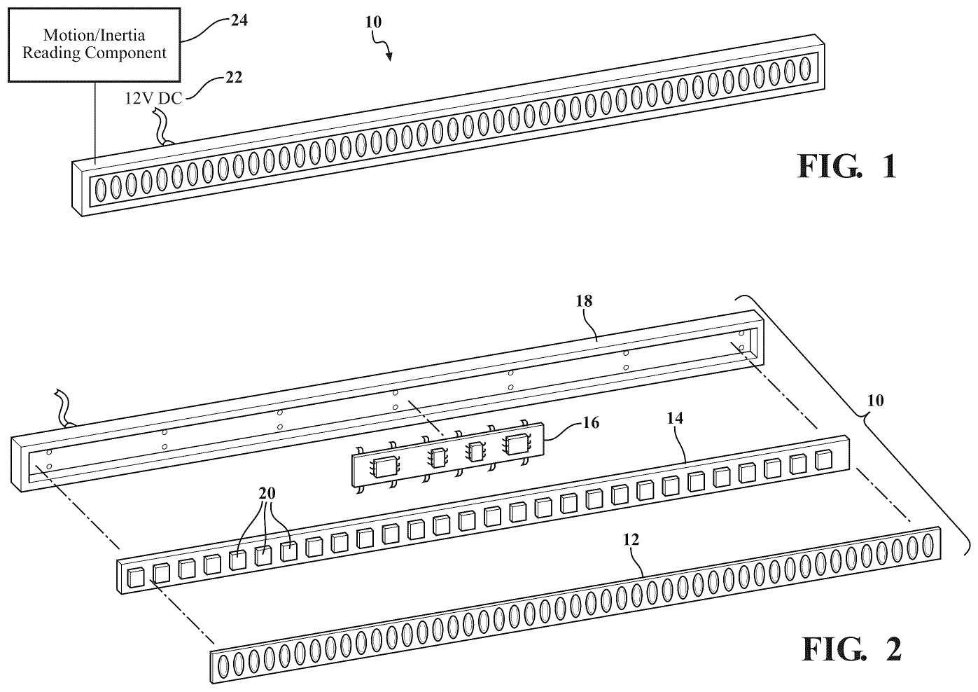

With reference to the attached illustrations, including the assembled perspective of FIG. 1, a visual lighting apparatus and alert assembly is shown at 10 according to a non-limiting embodiment of the present invention, for use with a school bus which signals each of travel/going and slowing conditions, such as to pedestrians and other drivers.

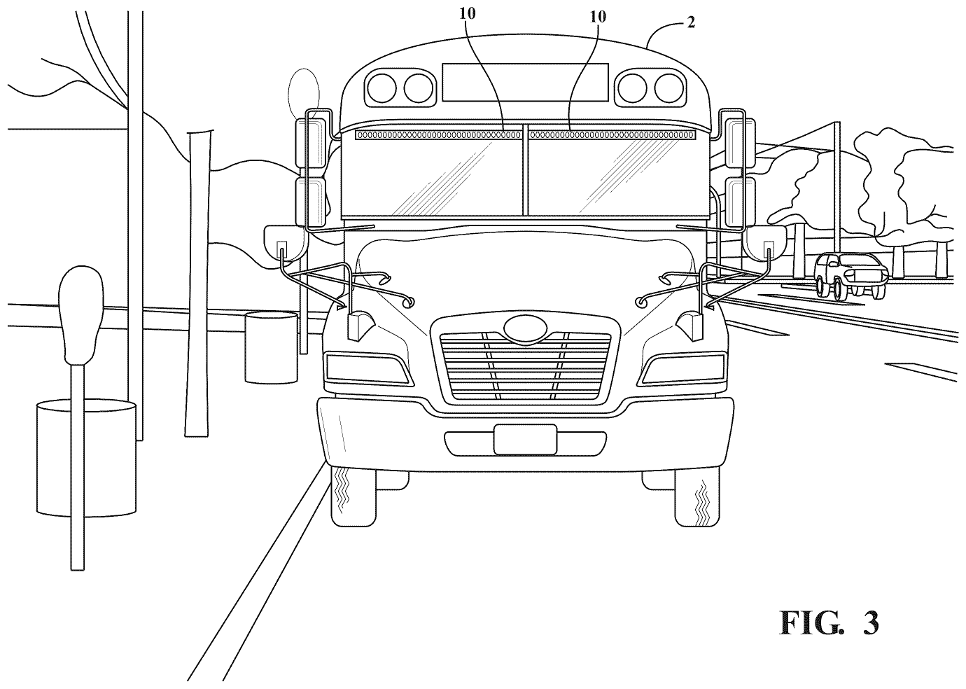

With reference to the exploded view of FIG. 2, the visual lighting apparatus of FIG. 1 includes each of a lens cover 12, LED supporting component 14, PCB 16 and backing support 18. In a non-limiting embodiment, the lighting assembly is configured as a flexible strip shaped component which is populated with a number of LED's or other illuminating elements (these depicted at 20 in FIG. 2) which are incorporated into the flex circuit.

The unit would run off of a 12 v DC power supply (at 22 in FIG. 1) and incorporates X-Y-Z motion detection (this can include the use of an accelerometer or other suitable motion/inertia reading component 24 which is in operative communication with the PCB 16). Without limitation, this would cover the bus moving forward and then stopping, and the Z-axis would handle L-R turns that might require a stop or acceleration during a turn or a complete STOP in a turn.

The motion/inertia reading component is typically provided as a vehicle accelerometer for determining each of going/slowing conditions which is then inputted to the PCB 16 in order to determine the color or pattern illumination. In vehicles, several types of accelerometers are used, each with its own strengths and applications: piezoelectric, piezoresistive, capacitive, and MEMS accelerometers. MEMS (Micro-Electro-Mechanical Systems) accelerometers are particularly common due to their small size and low cost, making them suitable for various automotive applications.

Vehicle accelerometers, used for measuring acceleration, further come in various types including capacitive, piezoelectric, piezoresistive and MEMS (micro electro-mechanical systems) accelerometers. Without limitation, the motion/inertia function provided by the accelerometer can be built into the assembly or can be provided as any of a separate component in communication with the visual alert assembly, such as without limitation being integrated into the vehicle control module.

The LED arrangement can include any suitable color scheme utilized in the assembly. Without limitation, one color scheme can include a pattern of RED, WHITE, AMBER extending across the length of the strip, with the intensity of the illumination variable depending upon need and application.

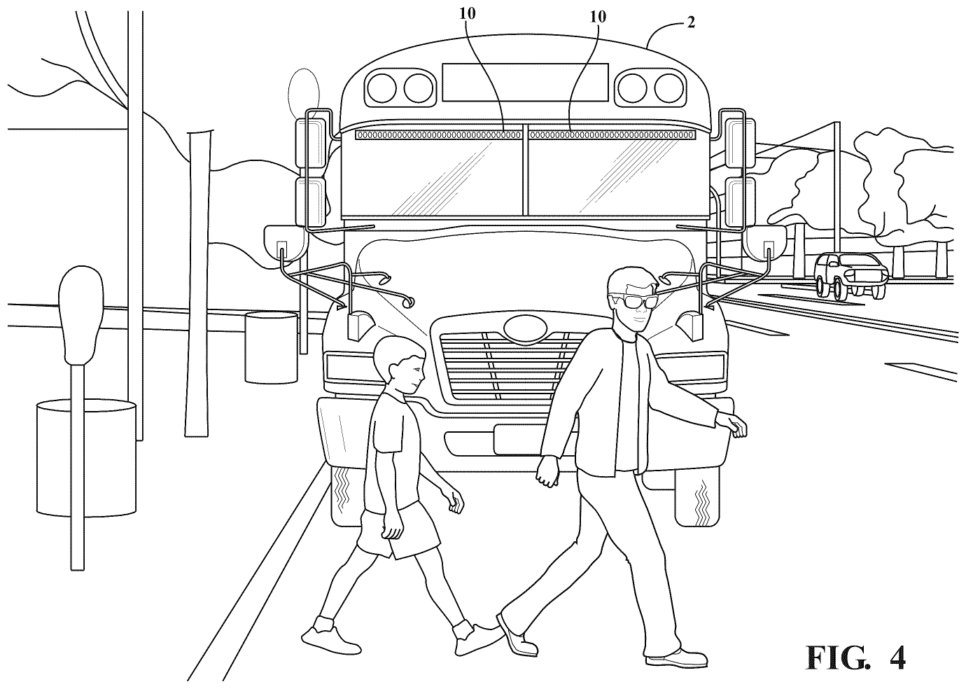

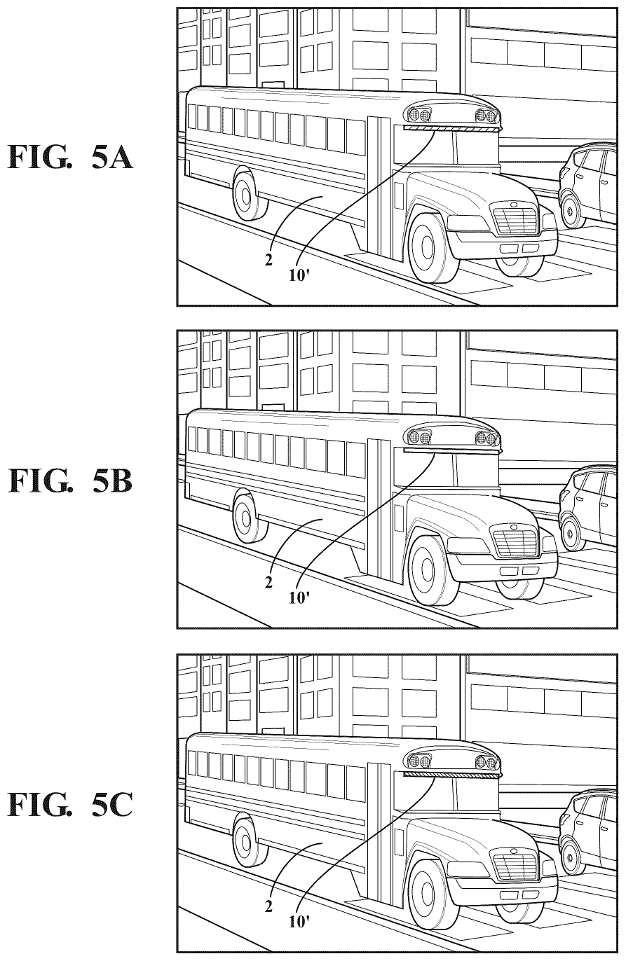

FIG. 3 is an environmental view of a school bus 2 incorporating a pair of visual lighting apparatuses 10 mounted to a forward facing windshield in a steady travel/going condition (such as represented by a white illumination from the LED's), with FIG. 4 presenting a further environmental view depicting the bus in a slowing condition (such as further represented by an amber or yellow illumination).

In operation, and as again shown in FIG. 3, when the school bus is moving the WHITE LEDs will illuminate. As the bus slows/starts to stop (see FIG. 4), the AMBER LEDs will turn on and remain lit until the bus comes to a complete STOP. At this point, the AMBER LEDs deactivate and the RED LEDs will glow and (optionally) flash on-off, signaling children may be exiting the bus.

In the instance of buses with two separate front windows separated by a pillar bar in the middle, the pair of strips (see again FIGS. 3-4) can be incorporated near the top of the windshield. Alternatively, it is also envisioned that a single strip could be used in the middle of the windshield for buses with continuous long-glass windshields.

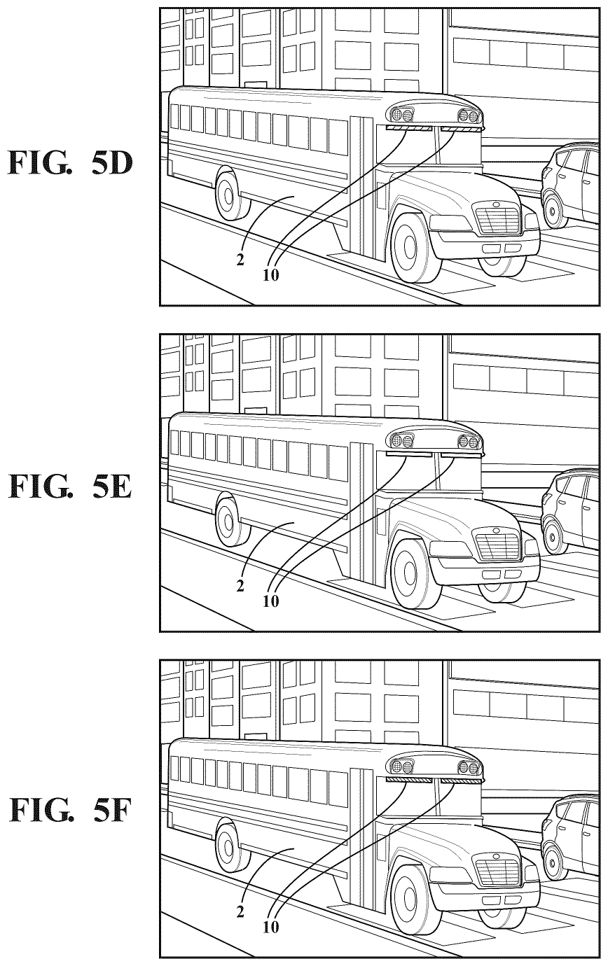

As further referenced in FIGS. 5A-5F, presented are a progression of environmental views depicting first (FIGS. 5A, 5B and 5C) and second (FIGS. 5D, 5E and 5F) versions of the visual lighting apparatus mounted to a forward facing upper windshield location of a school bus 2 according to additional non-limiting embodiments.

FIG. 5A depicts a continuous lighting assembly, see at 10′, mounted along an upper edge of the windshield and depicting an amber color representing the vehicle slowing, with FIG. 5B depicting a white color representing a continuous/going condition of the bus, and FIG. 5C depicting a red color representing the vehicle being stopped.

FIG. 5D depicts a pair of continuous lighting assemblies, again at 10 as previously shown in FIGS. 3-4, again mounted along an upper edge of the windshield and depicting an amber color representing the vehicle slowing, with FIG. 5E depicting a white color representing a continuous/going condition of the bus, and FIG. 5F depicting a red color representing the vehicle being stopped.

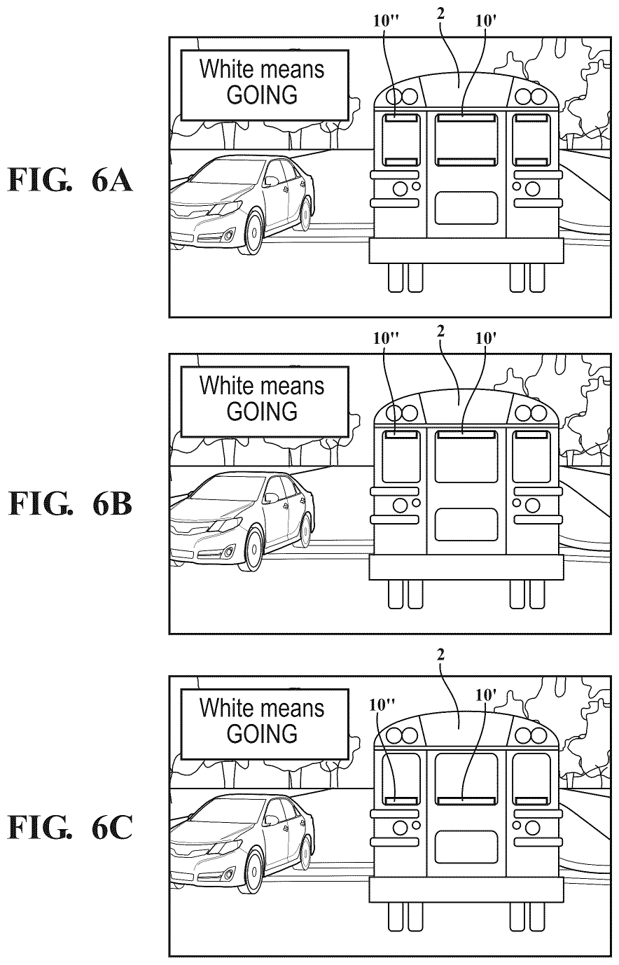

FIGS. 6A-6I present a further progression of environmental views depicting a series of additional versions of the visual lighting apparatus (see each of FIGS. 6A-6C for white/going, FIGS. 6D-6F for amber/slowing, and FIGS. 6G-6I for red/stopped) mounted to one or more rear windows of the school bus 2. For FIGS. 6A-6C this includes combinations of plural lighting apparatuses or assemblies, again at 10′ and at 10″, mounted along either or both of upper and lower extending edges of the rear windshields. This includes sets of both upper and lower combinations at 10′/10″ in FIG. 6A in a going/white condition, with FIG. 6B showing an upper edge extending combination and FIG. 6C a lower edge extending combination.

FIGS. 6D-6F correspondingly represent an amber/slowing condition for similar arrangements of lower, upper or both lower and upper windshield edge extending visual lighting assemblies, with FIGS. 6G-6I providing a matching set of views corresponding to 6D-6F in a red/stopped configuration.

The pairs of strips 10′/10″ mounted at the rear glass of the bus can be in sync with the front mounted assemblies 10. The behavior would be the same between the front and back mounted devices such that, in operation, the present invention would give any driver or pedestrian visual information about what the bus is doing, i.e. when it is going, stopping and entirely stopping, and unloading or loading children.

Additional features can include the provision of an ambient light sensor (also termed ALS) for managing an intensity of the illuminating/LED elements 18, such as which can be dependent upon exterior lighting conditions. By definition, an ALS is a photodetector that is used to sense the amount of ambient light present and, in response, adjusts the output intensity of the lights to match the ambient environment.

In operation, ambient light sensors (ALS) detect the amount of light in the environment and are used by systems that need this information such as headlight controls, interior lighting controls, and climate controls. Light sensors are generally based on one of three types of components: photoresistors, photodiodes or phototransistors.

Photoresistors or Photocells are two terminal components, and (as the name implies) the resistance between these terminals varies depending on the amount of light striking the component face. The resistance is proportional to changes in light intensity. However, they are relatively inaccurate and have a property called light “memory” which makes its response to a given light level dependent on previous ambient light levels. Photoresistors require external calibration in all but the simplest applications due to the variation in sensitivity between units and are generally the least expensive light detecting option and have a relatively slow (measured in milliseconds) response time.

Photodiodes are also two terminal components and are capable of developing a voltage across the terminals that is proportional to the amount of light striking the sensor surface. Photodiodes exhibit a linear relationship between their output current and the illumination level.

Phototransistors are two terminal transistors. The third terminal, the base in a bipolar transistor or the gate in a field-effect transistor, is replaced by the light collecting surface. The amount of light striking the surface supplies the base (or gate) current and regulates the amount of current that can flow from the collector to emitter (or source to drain). Phototransistors produce an output current proportional to the incident light intensity and are generally much faster than photoresistors and do not have the light “memory” property. However, the variation in sensitivity can be ±50% or more between units. Phototransistors are slightly more expensive than the other options, but they are more versatile and have quick (measured in nanoseconds) response times.

It is generally desirable for ambient light sensors to imitate the sensitivity of human eyes over the visual spectral range (380 nm to 780 nm with a peak response wavelength of about 550 nm). Unfortunately, most sensor's spectral response is not the same as the human eye because unlike the human eye, ambient light sensors generally respond to infrared (IR) and ultraviolet (UV) light as well. Therefore, displays and light brightness controlled by ambient light sensors may not be optimal for human eyes if IR light is not properly compensated. This issue can be addressed by self-compensating circuits or by using an IR filter within the unit.

Ambient light sensor products are gaining popularity as effective solutions for power management and increasing display quality in electronic products and systems. The battery life for portable electronics such as a cell phone or power savings in headlights can be increased significantly by automatic brightness control through ambient light sensor feedback.

Further to the above-description, and beyond that shown, the ALS can be located upon any of numerous locations including on the PCB such as depicted at 16 in FIG. 2. Beyond that, the ALS can also be relocated to any of the laminated circuit or other existing automotive systems which is optimized for sensing the ambient lighting conditions and providing the necessary illumination adjustment to the illuminating elements/LED's.

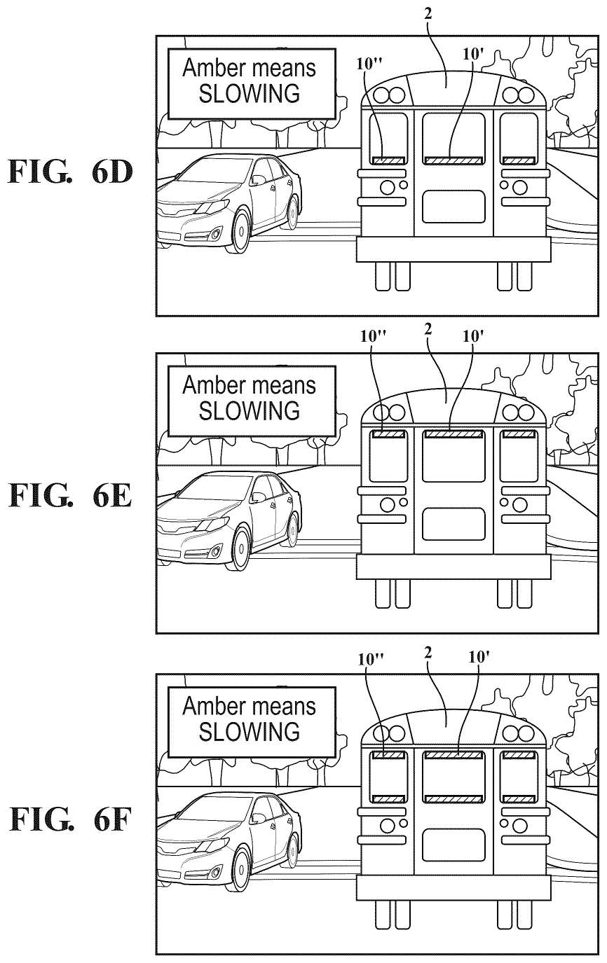

Proceeding now to FIG. 7, an exploded view is shown at 100 of a visual lighting apparatus/assembly according to a further non-limiting embodiment of the present invention. The assembly includes a body having a rear shell 102 exhibiting an elongated and shallow recessed pan interior for seating one or more PC boards (see as shown at 104 and 106).

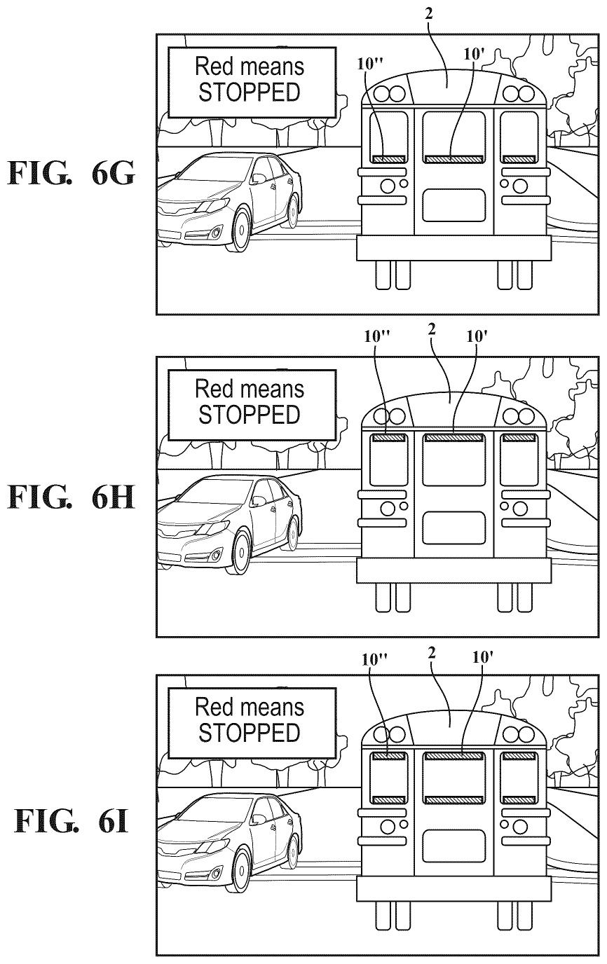

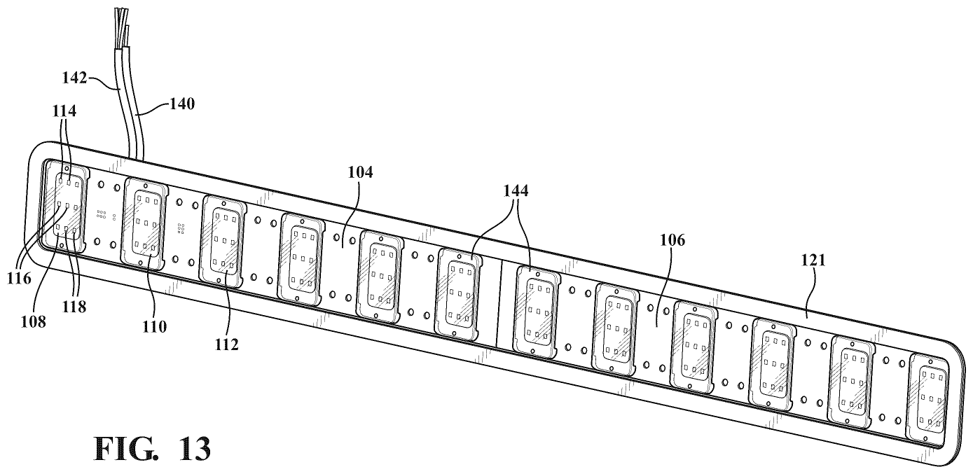

The PC boards further integrate individual groupings of illuminating elements (see at 108, 110, 112 et seq. for selected PC board 104 in selected FIGS. 8 and 13) and which, in non-limiting representation, can be provided as subset pluralities of WHITE 114, AMBER 116 and RED 118 light emitting (LED) diodes arranged in individual groupings corresponding to each overall illuminating element (see as best shown in each of FIG. 8 et seq.). As described herein, the WHITE, AMBER or RED LED's are alternately illuminated based upon the determined travel condition of the vehicle.

As best depicted in FIG. 8, the rear shell 102 can be constructed of any suitable material including without limitation an ABS (acrylonitrile butadiene styrene) plastic known for its impact resistance and toughness. The rear shell 102 exhibits a forward facing outer perimeter mounting surface 120 which, in combination with a two-sided adhesive perimeter extending strip 121, is adapted to mount said assembly to an inner windshield surface (see again FIGS. 3-6) of the vehicle, such as again a school bus, so that illuminating elements are visible through the windshield. As previously described, the school bus can have front and rear windows, with the body further comprising a plurality of bodies adapted to being mounted to each of the front window (windshield), as well as the rear windows as shown in FIGS. 3-6.

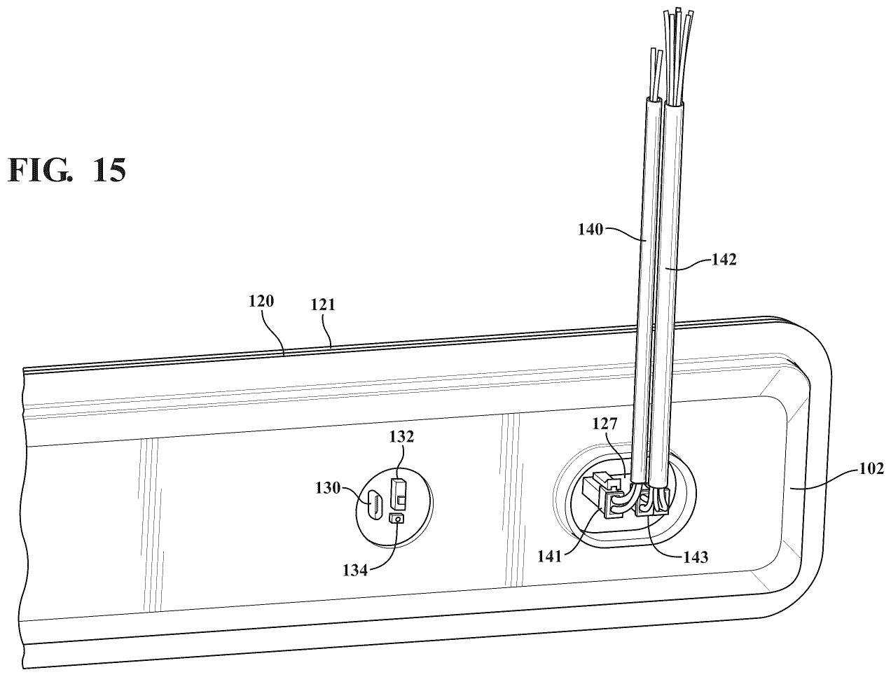

The rear shell 102 also includes apertures (see as represented by inner perimeter edges 122 and 124) formed in its base surface for receiving each of a separate power/control connector 126 and a separate covering cap 128 which, when removed, reveals a USB (universal serial bus) input 130 and associated upload connections (further at 132 and 134 in FIG. 15) communicating to the PC boards 104/106. Reference is also made to connection location 127 located on a reverse facing side of the PC board 104 to which the power 126 connector is engaged.

As further represented in FIG. 7, the PC boards 104/106 are arranged side-by-side having board-to-board connectors 136/138 for facilitating inter-communication. Without limitation, the pair of PC boards 104/106 can be substituted by a single overall PC board or any other number or arrangement PC boards.

The power/control connector 126, as further best shown in FIG. 15, includes one or more each of power 140 and conductor 142 connection wires (see as best shown in FIG. 15 by a pair of eighteen all weather gauge Power conductors 140, as well as six twenty two all weather gauge communication conductors 142), extending from locations of the vehicle for providing power and controller inputs, with respective input plug connections 141 and 143 (again FIG. 15) for incorporated into the power/control connector 126 for securing to the associated input connection 127 located on the reverse face of the PC board 104 for distributing power and operation of the illuminating/LED elements across the PC boars 104/106 according to any of intensity, color or pattern in response to a change in a travel condition of the vehicle. Without limitation, the power input can include a vehicle battery or separate power supply (not shown), with the controller input being provided by a motion/inertia reading component (see again as previously referenced at 24), with can further include a dedicated accelerometer or a suitable component integrated into an existing ECM (engine control module) for controlling various aspects of the engine operation of the vehicle.

Transparent covering elements 144 are provided which can include without limitation a transparent or translucent acrylic for mounting to a forward surface of the PC boards 104/106 over each of the individual groupings or pluralities of light emitting diodes (see again 114, 116 and 118 in FIG. 8). As further shown, the acrylic covering elements exhibit any shape suitable for covering the segregated groupings of the LEDS 114/116/118, with upper and lower mounting ends each exhibiting apertures (at 146 and 148) for receiving screws 150 (also termed self-tapping screws) which mount rearwardly through apertures 152 formed in upper and lower rows extending across the PC boards 104/106 for securing the covering elements 144 over the forward face of each PC board.

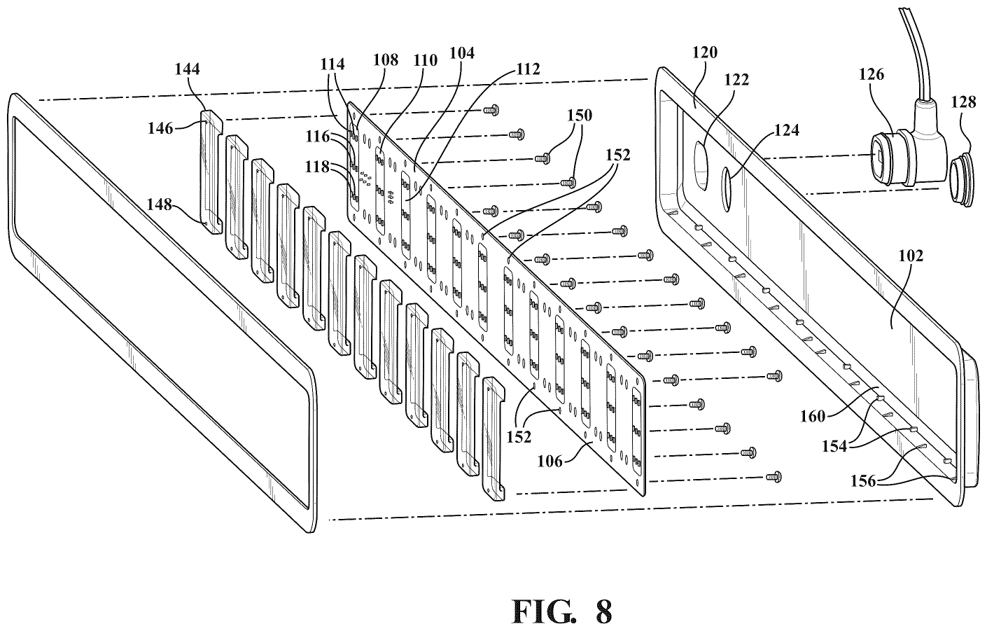

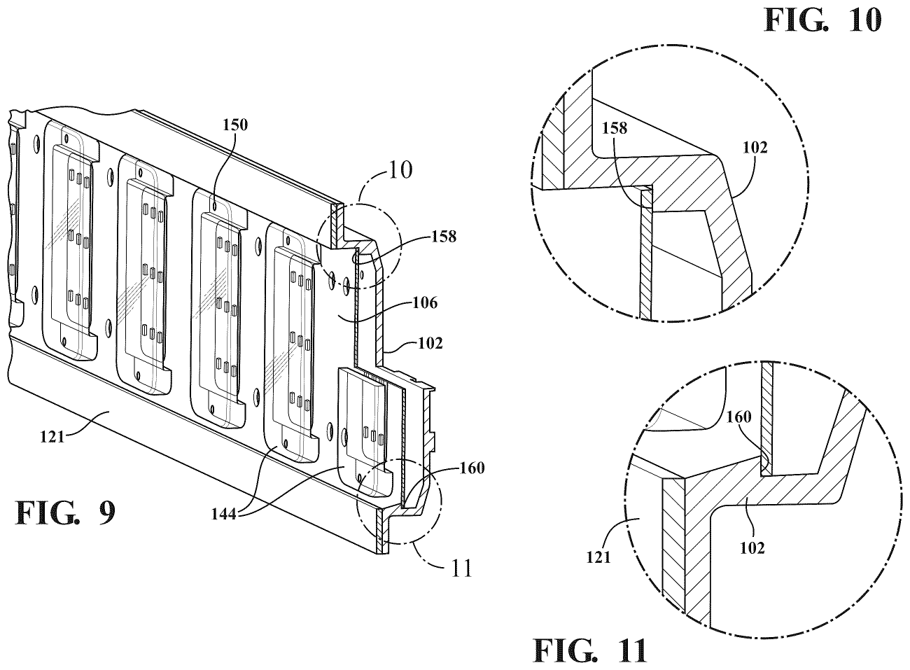

As best shown in the exploded view of FIG. 8, a combination of support ribs 154 and snap clips 156 are configured within each of upper and lower recessed inner edges of the rear shell 102 corresponding to each of the upper 158 and lower 160 (see respectively FIGS. 10-11) extending edges of said PC boards 104/106, these being arranged so that the ribs 154 are spaced apart rearwardly (as well as optionally offset as shown) relative to the angled snap clips 156 for securing the PC boards 104/106 and the acrylic LED covering elements 144 in a recessed and rearwardly supported fashion relative to the forward facing and perimeter defined support mounting surface 120.

Having described my invention, other and additional preferred embodiments will become apparent to those skilled in the art to which it pertains, and without deviating from the scope of the appended claims. The detailed description and drawings are further understood to be supportive of the disclosure, the scope of which being defined by the claims. While some of the best modes and other embodiments for carrying out the claimed teachings have been described in detail, various alternative designs and embodiments exist for practicing the disclosure defined in the appended claims.

The foregoing disclosure is further understood as not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosure. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application. Additionally, any signal hatches in the drawings/figures should be considered only as exemplary, and not limiting, unless otherwise specifically specified.

1. A visual alert assembly for use with a vehicle, comprising:
a rear shell seating one or more PC boards integrating illuminating elements;
a forward facing outer perimeter mounting surface of said shell including an adhesive adapted to mount said assembly to a glass associated with any of a forward windshield or rear window of the vehicle so that said illuminating elements are visible through the glass; and
each of external power and control inputs extending through said rear shell and communicating with said PC boards for operating said illuminating elements according to any of intensity, color or pattern in response to a change in a travel condition of the vehicle.

2. The visual alert assembly of claim 1, said illuminating elements further comprising individual pluralities of light emitting diodes including each of RED, WHITE and AMBER color extending across a length of said PC boards which are separately illuminated dependent upon the travel condition of the vehicle.

3. The visual alert assembly of claim 2, further comprising transparent covering elements mounting to a forward surface of said PC boards over each of said individual pluralities of light emitting diodes.

4. The visual alert assembly of claim 3, further comprising screws extending through a rearward surface of said PC boards for mounting said covering elements.

5. The visual alert assembly of claim 1, further comprising a combination of support ribs and snap clips are configured along inner edges of said rear shell and corresponding in arrangement to upper and lower extending edges of said PC boards for securing said PC boards within said rear shell rearwardly of said forward facing mounting surface.

6. The visual alert assembly of claim 1, further comprising a universal serial bus input connected to a processor integrated into said PC boards and accessible through said rear shell.

7. The visual alert assembly of claim 1, further comprising said control input in communication with a motion/inertia reading component for determining the travel condition of the vehicle.

8. The visual alert assembly of claim 1, said one or more PC boards further comprising a pair of PC boards in a side-by-side arrangement and having board-to-board connectors.

9. The visual alert assembly of claim 7, said motion/inertia reading component further comprising a vehicle accelerometer.

10. The visual alert assembly of claim 1, said adhesive further comprising a two-sided perimeter extending adhesive strip.

11. The visual alert assembly of claim 10, further comprising an ambient light sensor associated with said PC boards for managing an intensity of said illuminating elements based upon ambient lighting conditions.

12. A visual alert assembly for use with a vehicle, comprising:
a body including a rear shell seating one or more PC boards integrating illuminating elements;
said illuminating elements further including individual pluralities of light emitting diodes including any combination of colors extending across a length of said PC boards which are separately illuminated dependent upon the travel condition of the vehicle;
a forward facing outer perimeter mounting surface of said shell including a two-sided adhesive adapted to mount said assembly to a glass associated with any of a forward windshield or rear window of the vehicle so that said illuminating elements are visible through the glass; and
each of external power and control inputs extending from a location of the vehicle through said rear shell and communicating with said PC boards for operating said illuminating elements according to any of intensity, color or pattern in response to a change in a travel condition of the vehicle.

13. The visual alert assembly of claim 12, further comprising transparent covering elements mounting to a forward surface of said PC boards over each of said individual pluralities of light emitting diodes.

14. The visual alert assembly of claim 13, further comprising screws extending through a rearward surface of said PC boards for mounting said covering elements.

15. The visual alert assembly of claim 12, further comprising a combination of support ribs and snap clips are configured along inner edges of said rear shell and corresponding in arrangement to upper and lower extending edges of said PC boards for securing said PC boards within said rear shell rearwardly of said forward facing mounting surface.

16. The visual alert assembly of claim 12, further comprising a universal serial bus input connected to a processor integrated into said PC boards and accessible through said rear shell.

17. The visual alert assembly of claim 12, further comprising said control input in communication with a motion/inertia reading component for determining the travel condition of the vehicle.

18. The visual alert assembly of claim 12, said one or more PC boards further comprising a pair of PC boards in a side-by-side arrangement and having board-to-board connectors.

19. The visual alert assembly of claim 17, said motion/inertia reading component further comprising a vehicle accelerometer.

20. The visual alert assembly of claim 12, further comprising an ambient light sensor associated with said PC boards for managing an intensity of said illuminating elements based upon ambient lighting conditions.
